(19) United States
(12) Patent Application Publication
(10) Pub. No.: US 2024/0152110 A1
(43) Pub. Date: May 9, 2024

(54) METHOD FOR GENERATING A VIRTUAL GEOMETRY, AND SYSTEM FOR DATA PROCESSING

(71) Applicant: FRAUNHOFER-GESELLSCHAFT ZUR FÖRDERUNG DER ANGEWANDTEN FORSCHUNG E.V., München (DE)

(72) Inventors: Philipp GANSER, Aachen (DE); Vincent GERRETZ, Aachen (DE); Tommy VENEK, Aachen (DE)

(21) Appl. No.: 18/281,164

(22) PCT Filed: Mar. 9, 2022
(86) PCT No.: PCT/DE2022/100193

§ 371 Date: Sep. 8, 2023

(30) Foreign Application Priority Data
Mar. 12, 2021 (DE) 102021106116.4

(51) Int. Cl. G05B 19/4065

(52) U.S. Cl. CPC G05B 19/4065; G05B 2219/37256

(57) ABSTRACT

The invention relates to a method, in particular a computer-implemented method, for generating a virtual geometry (32), a method for generating a digital twin, and a data processing system and computer program. In particular, the invention relates to a method, in particular a computer-implemented method, for generating a virtual geometry of a component (8) which is produced and/or is to be produced with a processing machine (2) and which comprises the steps: Acquisition of machine information (12, 14) which characterizes at least one machine parameter of the processing machine (2) influencing a geometry of the component (8), determination (230, 240, 250) of at least one component factor (30) based on the machine information (12, 14) and the nominal geometry (10), and generation (260) of a first virtual geometry (32) as a digital geometric image of the component (8) produced and/or to be produced based on the component factor (30).

The invention relates to a method, in particular a computer-implemented method, for generating a virtual geometry, a method for generating a digital twin, and a system for data processing and a computer program.

Methods for generating a virtual geometry of a component produced by a processing machine with a nominal geometry are known in principle. These methods are usually based on measuring methods which are used to measure the produced component.

The manufacture of components with processing machines is usually subject to quality fluctuations due to the influence of errors on the manufacturing process. The errors that occur are divided into systematic errors and random errors. Systematic errors are system-related and reproducible under the same boundary conditions. A systematic defect can be, for example, tool wear of the applied machining tool or thermally induced expansion of components of the applied machining machine. Remaining errors whose origin is not a systematic error are to be assigned to the random errors. Such errors cannot usually be predicted deterministically. Random errors can be caused, for example, by material properties deviating from a specification or by changing ambient temperatures.

To take account of the large number of factors influencing the manufacturing process, quality assurance is performed to ensure component quality. During quality assurance, the produced component is measured using predetermined measuring equipment. It is also possible to measure the component between two production steps.

For example, dimensional, form and position tolerances are checked as part of quality assurance. Geometrical deviations of the component can be detected, for example, using tactile coordinate measuring technology or optical fringe light projection. Particularly in the case of complex component geometries, which comprise free-form surfaces, for example, the available measuring methods are time-consuming and cost-intensive. For components with complex component geometries, downstream quality assurance can account for up to 25% of the component costs.

Furthermore, the investment costs for measuring equipment are high. Furthermore, measuring equipment must be regularly maintained and tested to ensure its functionality.

WO2016/065492 describes a computer-implemented method for partial analysis of a workpiece that has been machined by at least one NC machine, essentially simulating the machining process and, in particular, not replacing any measuring process. In particular, further measurement steps are required after the production of the part in order to determine the quality of the part. For example, no technological effects and their interactions are modeled here, so that the determined result is inaccurate.

It is therefore an object of the present invention to provide a method, in particular a computer-implemented method, for generating a virtual geometry of a component produced and/or to be produced with a processing machine with a nominal geometry, a method for generating a digital twin, a system for data processing and a computer program, which reduce or eliminate one or more of the disadvantages mentioned. In particular, it is an object of the invention to provide a solution that reduces or eliminates the measurement effort in the context of quality assurance.

This task is solved with a method, a system for data processing and a computer program according to the features of the independent patent claims. Further advantageous embodiments of the method, the system for data processing and the computer program are indicated in the respective dependent patent claims. The features listed individually in the patent claims can be combined with one another in any technologically useful manner and can be supplemented by further features from the description, wherein further embodiments of the invention are shown.

The method for generating a virtual geometry of a component which is produced and/or is to be produced with a processing machine and has a nominal geometry, comprising the steps of: acquiring machine information characterizing at least one machine parameter of the processing machine influencing a geometry of the component, determining at least one component factor, based on the machine information and the nominal geometry, and generating a first virtual geometry as a digital geometric image of the component which is produced and/or is to be produced, based on the component factor.

In particular, the method is a computer-implemented method. The method is configured to generate a virtual geometry. A virtual geometry is understood in particular as a geometric image of a component produced and/or to be produced. The virtual geometry of a produced component can be comparable to a measurement result of a three-dimensional measurement process. For example, the virtual geometry is a point cloud whose surface is an image of the produced component. Further, the virtual geometry may be or comprise a polygon mesh, non-uniform rational B-splines, a bounding surface model, a solid constructive geometry, a dexel, a multi-dexel, a voxel, and/or an octree. A virtual geometry of a component to be manufactured can also be understood as a prediction geometry. In this case, a virtual geometry of a component to be manufactured is generated.

A geometry is understood to be, for example, a macro geometry of the component. Among other things, the macro geometry describes the shape and dimensions of a component. In addition, a geometry is also understood to mean a microgeometry.

The microgeometry describes, among other things, a surface topography and/or a surface finish. Preferably, a geometry is understood to be a measurable property of a component.

The component is produced with a processing machine or is to be produced with a processing machine. For example, the processing machine may be a milling machine or a lathe. In addition, the processing machine can be any machine for carrying out a manufacturing process.

The component produced and/or to be produced has a nominal geometry. In particular, the nominal geometry is the geometry that has been provided or predefined for the component being produced and/or manufactured. The nominal geometry of the component is usually specified in the design. The nominal geometry can, for example, define the shape and dimensions of the component to be manufactured and/or other parameters, such as a surface finish or surface topography.

In a first step, machine information is acquired. Machine information can also be understood to mean machine data. Acquisition of machine information is basically understood to mean any method for acquiring, collecting, reading out, obtaining and the like machine information. The machine information characterizes at least one machine parameter of the processing machine influencing the geometry of the component during manufacture. The machine parameter may be, for example, one, two or more axis positions or one, two or more power values, as will be explained in more detail below.

Machine information can be acquired, for example, by means of sensors. Acquisition of machine information is further understood to mean the collection of information or data. For example, the machine information can be acquired such that a machine controller of the processing machine is read out, and the machine information is acquired in this way. Alternatively or additionally, the machine information can be read out from further data memories and/or data sources. Furthermore, the acquisition of machine information can also be performed in a calculatory manner, in particular by calculating the machine information by means of a model.

Furthermore, the method comprises determining at least one component factor based on the machine information and the nominal geometry. The component factor results from the machine information and the nominal geometry. The component factor thus takes into account the machine information and the nominal geometry and is configured in particular such that the first virtual geometry can be generated with it.

The invention is based on the realization that the geometry of a produced component can be determined not only on the basis of a measurement process on the component itself, but also on the basis of machine information. The inventors have discovered that the actual or virtual geometry of the component can be deduced by cleverly linking machine information and the nominal geometry on which the component is based.

Since the machine information is usually available anyway in modern processing machines and the nominal geometry of the component to be manufactured is available on the basis of the CAD designs, the method makes it possible to determine the component geometry in-situ, so that a subsequent test step with a measuring device or a measuring method is not necessary. As a result, the cost of subsequent testing is reduced or avoided, essentially eliminating the 25% component cost for quality assurance mentioned in the previous. In addition, 100% inspection of all components can be performed, thus eliminating the need for the error-prone random sampling that is common in modern measurement techniques. Furthermore, based on the first virtual geometry and the second virtual geometry, which will be explained in more detail below, statistical process control can be performed or supported. For example, process control can be performed between the drawing of two samples based on the first virtual geometry, since there is a higher data availability through the method.

Based on the component factor, the first virtual geometry is subsequently generated as a digital geometric image of the component produced and/or to be produced. For example, the first virtual geometry can be generated in such a way that, based on the nominal geometry, a deviation is determined at predefined points of the nominal geometry by means of the component factor.

The inventors have verified by experimental means the method described in the foregoing. It has been shown that the first virtual geometry is substantially the same as the geometry generated by complex three-dimensional measurement techniques. Partially, it has been shown that the method described in the preceding gave a more realistic result.

A preferred embodiment of the method is characterized in that the machine information characterizes axis positions of at least one machine axis and/or one machine spindle of the processing machine. Preferably, the machine information characterizes axis positions of two or more or all machine axes. Axis positions of a machine axis can usually be read out from a machine control of the processing machine.

The machine axes may be, for example, the axes of a machine table, a build chamber of an additive manufacturing machine, and/or a laser scanner. The machine spindle can be, for example, a tool spindle of a milling machine or a lathe spindle for rotationally driving a component.

An axis position is preferably defined as a distance from a predefined point of a machine component to a predefined zero point, in particular at a specific time. Preferably, the method comprises the step of: detecting axis positions of at least one machine axis, preferably two or more or all machine axes. This detection can also be a readout of a machine control of the processing machine. The axis positions are specified in particular as a function of time or are linked to a time unit. On the basis of this, additional speeds, accelerations and reverses can be determined by differentiation.

In a further preferred embodiment of the method, it is provided that the machine information characterizes power values of the at least one machine axis, preferably of the two or more or of all machine axes, and/or of the machine spindle of the processing machine. For example, the power values may be expressed directly in watts or kilowatts. In addition, the power values may be indicated indirectly, for example in amperes or percent. In particular, the power values are specified as a function of time or are linked to a unit of time. In particular, the power values are power values of a drive of the machine axis.

In a further preferred embodiment of the method, it is provided that an initial geometry of the workpiece to be machined is taken into account.

It is preferred that the method comprises the step of: Acquiring power values of the at least one machine axis, preferably of the two or more or of all machine axes, and/or of the machine spindle of the processing machine. The sensing may also be a readout of the machine controller and/or a calculation of the power values.

In the following, axis positions and information characterizing axis positions as well as power values and information characterizing power values are partly used synonymously. Furthermore, it is preferred that the power values and the axis positions are set in relation to each other. A relation can be made, for example, by means of a temporal variable and/or a temporal link.

A preferred further embodiment of the method comprises the steps of: determining a process force, in particular process forces, by means of the power values and a contact area between an applied tool and the component, and determining a displacement factor, which is determined by means of a tool displacement and/or a component displacement based on the process force, wherein the component factor is determined based on the displacement factor.

Whereby the component factor is determined based on the displacement factor, means in particular that the component factor is determined based, inter alia, on the displacement factor.

In particular, it is preferred that process forces are determined. Process forces are generally known in manufacturing technology as forces acting on the component and/or on the tool and/or between the tool and the component and/or transmitted via a medium between the tool and the component. Furthermore, process forces are defined as forces resulting from the manufacturing process that influence the process result. A single process force of the process forces is preferably determined as a force vector, namely in three spatial directions, in particular in the direction of the machine axes X, Y and Z. Among other things, the process force is determined as a function of the tool position.

The contact area between the applied tool and the component is generally known in manufacturing technology as the contact geometry. In practice, the contact area is determined analytically and/or discretely. The contact area is essentially determined by the component geometry to be machined, the tool geometry, and their position and orientation relative to each other.

The contact area can, for example, be configured as a line contact or as a surface contact. In practice, the contact area is determined analytically and/or discretely. The contact area is essentially defined by the component geometry to be machined, the tool geometry and the engagement conditions, for example a tool angle between the tool and the component.

The applied tool can be, for example, a machining tool or a laser beam. In addition, the tool can be any element influencing a workpiece in a manufacturing process.

The inventors have found that tool displacement and/or component displacement during the manufacturing process of a component often has an influence on the deviation of the produced component geometry from the nominal geometry. Depending on the applied tool and the produced component, the tool misalignment or the component misalignment is of greater relevance.

For example, component displacement is often more relevant than tool displacement for a filigree component, such as a thin-walled component like an integral axial compressor impeller or a thin-walled engine blade. In contrast, tool displacement is more relevant than component displacement when machining a deep-drawing tool weighing several tons. Tool displacement and component displacement are essentially determined on the basis of the process force. Due to the process force acting between the component and the tool, the tool displacement and component displacement, respectively, occur. The tool and/or component displacement can be based, for example, on numerical approximation tests or analytical models, such as the mechanical model of a bending beam. The tool and component displacement can characterize a displacement and/or a deformation of the component and/or the tool.

Furthermore, it is preferred that a clamping means factor is determined based on an applied clamping means for clamping the component and/or the tool and/or clamping parameters. A clamping means can cause a deformation of the component and/or the tool. Furthermore, the dynamic and static properties can be influenced.

Based on the tool displacement and/or the component displacement, the displacement factor is determined. In particular, the displacement factor reflects a spatially resolved deviation that takes into account that the component and/or a machining-relevant section of the tool are not in the position that was provided for the component and/or the tool in the process planning. For example, a geometry deviating from the nominal geometry is produced by moving the tool center point and/or moving the component or a section of the component. Furthermore, it is preferred that the clamping means factor is taken into account when determining the displacement factor.

Another preferred further embodiment of the method comprises the step of: determining a position factor based on the axis positions, and wherein the component factor is determined based on the position factor. The position factor takes into account that the tool as such is not in the position that was intended for the tool in the process planning. This is caused by spatially resolved deviations of the real axis positions from the specified axis positions. These deviations can be caused by accelerations and reverses, for example, so that the machine does not move to the predefined points. It is particularly preferred that the position factor is determined, among other things, on the basis of the contact range determined with the axis positions.

Furthermore, an NC path mapped in the NC program may have deviations because the NC program may be subject to errors. For example, the deviations may be caused by errors and inaccuracies in the CAM algorithm and by human error. These deviations are precisely detected by which method.

In addition, in an NC program, the points are defined at a distance from each other, and interpolation is performed between the points for machine guidance. This also results in a deviation. It is particularly preferred that the detected axis positions are taken into account with consideration of the nominal geometry, so that no nominal positions of the processing machine have to be taken into account.

Whereby the component factor is determined based on the position factor, means in particular that the component factor is determined based, among other things, on the position factor.

A further preferred embodiment of the method comprises the step of: determining a tool factor based on a tool geometry, and wherein the component factor is determined based on the tool factor. The tool factor accounts for a deviation caused by the tool not having the geometry that was provided for the tool in the process planning.

Whereby the component factor is determined based on the tool factor means, in particular, that the component factor is determined based on, among other things, the tool factor.

Preferably, the tool geometry is determined based on an initial condition and/or based on tool wear. The initial state describes the geometry of the tool before the first use. In particular, the initial state takes into account a deviation of the initial state from a predetermined nominal geometry of the tool, this deviation being caused, for example, by imprecise manufacture of the tool. Among other things, the tool geometry describes dimensions, for example a tool length or a tool diameter, a shape of the tool and/or a tool runout. During the use of the tool, tool wear always occurs, which usually changes the tool geometry continuously.

Machining a component with a tool that has a tool geometry that deviates from a nominal tool geometry results in a produced component that deviates from the nominal geometry. It is preferred that tool wear is determined based on contact area and/or based on process force. For example, tool wear can be determined using empirical modeling, taking into account the contact area, which varies over time, process forces, and additional coupled sensor information, such as from camera systems or laser measurement systems.

In addition, the tool may deform during machining, for example in an area adjacent to the tool center point. Due to this deformation, a deviation also occurs, which can be taken into account with the tool factor.

Another preferred embodiment of the method comprises the step of: acquiring metainformation, wherein the metainformation represents tool parameters of the tool, machine kinematics of the machining machine and/or program names, and wherein the metainformation is used to determine the displacement factor and/or to determine the contact area.

The machine kinematics causes individual deviations that are superimposed to form an overall error called volumetric error. The superposition of all systematic individual errors in linear and rotary axes of a processing machine causes a location-specific offset of the tool relative to a predefined position as well as a location-specific deviation from a predefined orientation at each position of the working area.

Metadata are additional structured data representing further information about the part, for example an identification code, a material or a coordinate offset, about the tool, for example an identification code, a tool type, a tool radius, and about the processing machine, for example an identification code, a machine kinematics or a machine configuration. The program names enable NC operations to be assigned to a component and a machining sequence to be defined.

In a further preferred embodiment, the method comprises the step of: Acquiring sensor information, wherein the sensor information characterizes force values, moment values, in particular bending moment values, vibration values and/or tool displacement values, and wherein the sensor information is used to determine the process force.

The force values can be determined, for example, by means of sensory tool holders, spindle-integrated force measurement systems and/or workpiece-side force measurement platforms. The process forces can be determined with the force values and/or torque values. The vibration values can be used to determine the dynamic compliance of the tool and/or the component. Furthermore, tool wear and/or tool runout can be determined using laser tool measurement systems or camera systems.

In particular, the sensor information is output signals from sensors, especially force sensors, vibration sensors, and/or tool displacement sensors. The sensors can be, for example, discrete sensors or time series sensors.

Furthermore, it is preferred that the contact area is determined based on the tool geometry of the tool and the nominal geometry of the component and/or the first virtual geometry. Further preferably, a position and orientation between the tool and the component are taken into account. The determination or the determination of the contact area, based on the tool geometry and the first virtual geometry, is particularly important in the determination of the second virtual geometry, which will be explained in more detail below. Since the contact area is dependent on the geometry produced or to be produced, it actually deviates from the contact area determined based on the nominal geometry. Therefore, in order to determine a more accurate virtual geometry, the contact area can be determined based on the tool geometry and the first virtual geometry.

Another preferred embodiment of the method comprises the steps of: determining a modified part factor based on the machine information and the first virtual geometry, and generating a second virtual geometry based on the modified part factor. The determination of the part factor can be improved because there are interactions between the displacement factor, the position factor, and the tool factor that can lead to deviations. For example, the deviation of the actually produced geometry from the nominal geometry leads to a changed contact area and a changed process force. Other influencing factors can also be changed by the deviations.

By taking the first virtual geometry into account instead of the nominal geometry, a more precise determination of the component factor is made possible. In particular, it is preferred that a third and further virtual geometries are determined, in each of which the previously determined virtual geometry is taken into account as the initial geometry. Thus, a more precise modified component factor can be determined iteratively.

In particular, it is preferred that a modified displacement factor, a modified position factor and/or a modified tool factor is determined based on the first virtual geometry and/or based on a deviation between the first virtual geometry and the nominal geometry.

Preferably, a modified process force is determined based on the power values and a modified contact area. In particular, the modified contact area takes into account the first virtual geometry and preferably does not take into account the nominal geometry of the component. Based on the modified process force, a modified tool displacement and/or a modified component displacement is preferably determined.

Based on the modified tool displacement and/or the modified component displacement, the modified displacement factor is determined. The modified component factor is preferably based on the modified displacement factor. Also, the modified tool factor usually differs from the tool factor because the engagement conditions of the tool change due to the deviation of the first virtual geometry from the nominal geometry.

Another preferred further embodiment of the method comprises the step of: determining a geometry deviation by matching the first virtual geometry and/or the second virtual geometry to the nominal geometry, preferably generating a deviation vector in each case in predefined component sections of the nominal geometry.

According to a further aspect, the aforementioned task is solved by a method for generating a digital twin of a produced component, based on machine information and a nominal geometry of the component, in particular by means of a method according to one of the embodiments described above.

According to a further aspect, the aforementioned task is solved by a system for data processing, comprising means for carrying out the steps of the method according to one of the embodiments described in the foregoing.

The system is configured in particular for generating a virtual geometry of a component which is produced and/or is to be produced with a processing machine and which has a nominal geometry. Preferably, the system for data processing comprises means for acquiring machine information characterizing at least one machine parameter of the processing machine influencing a geometry of the component.

Further preferably, the system for data processing comprises means for determining at least one component factor based on the machine information and the nominal geometry. Furthermore, it is preferred that the system for data processing comprises means for generating a first virtual geometry as a digital geometric image of the component produced and/or to be produced based on the component factor.

Preferably, the system comprises an interface configured to couple the system to an external system. For example, the system may be couplable to a CAQ system of a quality assurance system by means of the interface.

According to a further aspect, the task mentioned at the outset is solved by a computer program comprising instructions which, when the computer program is executed by a computer, cause the computer program to execute the method according to one of the embodiments described in the foregoing.

For further advantages, variants of embodiment and details of embodiment of the further aspects and their possible further embodiments, reference is also made to the description given previously concerning the corresponding features and further embodiments of the method for generating a virtual geometry of a component produced and/or to be produced with a processing machine with a nominal geometry.

Preferred examples of embodiments are explained by way of example with reference to the accompanying figures: They show:

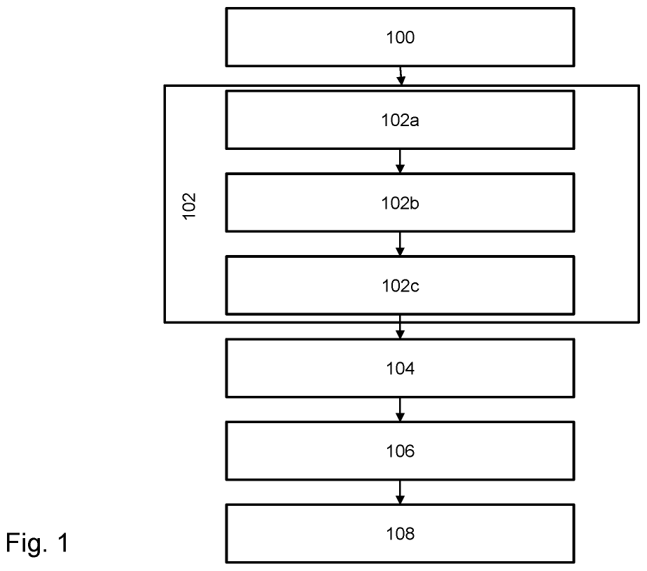

FIG. 1: a schematic representation of an exemplary embodiment of a method for generating a virtual geometry;

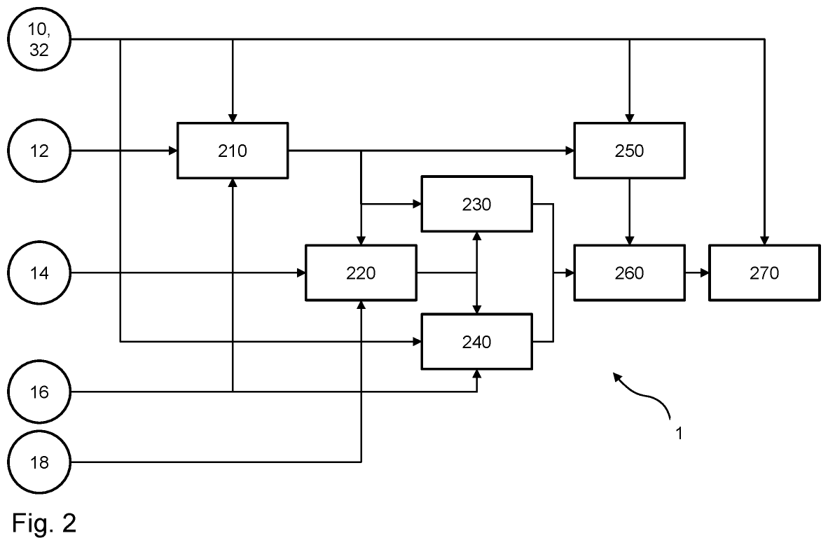

FIG. 2: a schematic representation of an exemplary embodiment of a system for data processing;

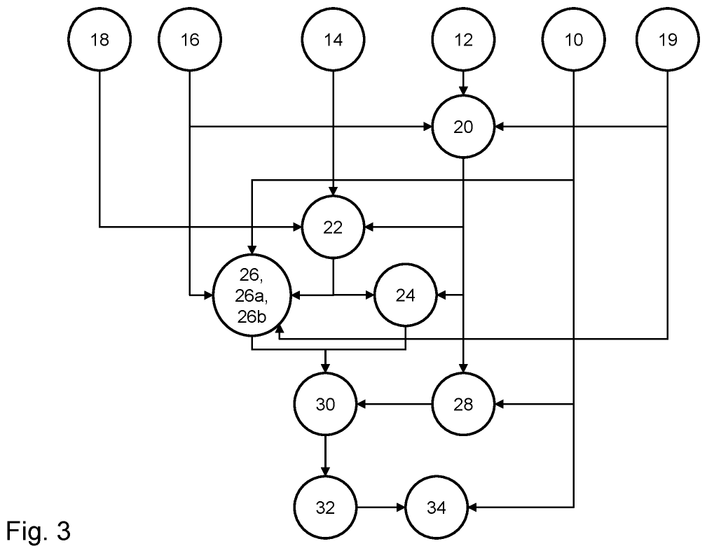

FIG. 3: a schematic representation of the information flows in a system for data processing;

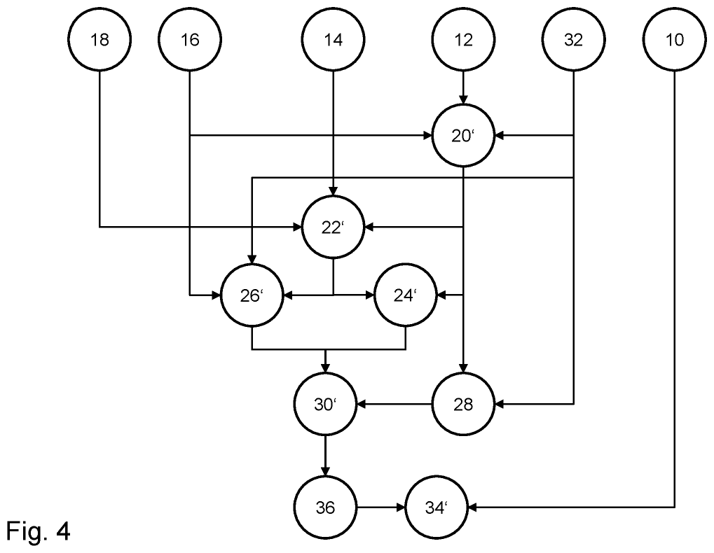

FIG. 4: another schematic representation of the information flows in a data processing system; and

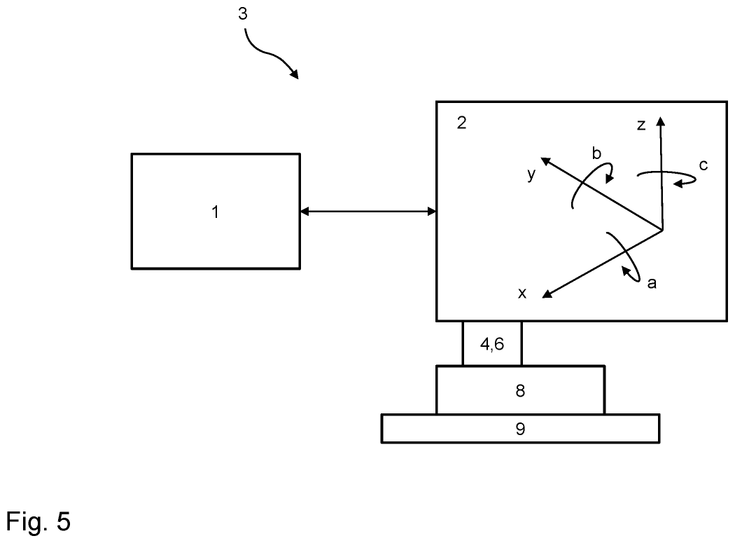

FIG. 5: a schematic representation of an exemplary embodiment of a manufacturing system.

In the figures, identical or essentially functionally identical or similar elements are designated by the same reference signs.

FIG. 1 shows a schematic method. In step 100, machine information 12, 14 is acquired that characterizes at least one machine parameter of the processing machine 3 that influences the geometry of the component 8. The machine information can, for example, characterize axis positions 12 and/or power values 14 of at least one machine axis x, y, z, a, b, c.

In step 102, at least one component factor 30 is determined, based on the machine information 12, 14 and the nominal geometry 10 of the component 8 produced and/or to be produced. Step 102 is divided into steps 102a, 102b and 102c. In step 102a, a displacement factor 26 is determined. For this purpose, a process force 22 is first determined by means of the power values 14 and a contact area 20 between an applied tool 6 and the component 8. Then, the displacement factor 26 is determined based on a tool displacement 26a and/or a component displacement 26b, wherein the tool displacement 26a and/or the component displacement 26b is determined based on the process force 22.

In step 102b, position factor 28 is determined, based on axis positions 12. In step 102c, tool factor 24 is determined, based on tool geometry. Steps 102a, 102b, and 102c can be performed in any order, for example, in parallel. Further, step 102 may be performed with only one or two of steps 102a-c. The component factor 30 is determined based on the displacement factor 26, the position factor 28, and the tool factor 24.

In step 104, a first virtual geometry 32 is generated as a digital geometric image of the component 8 produced and/or to be produced, based on the component factor 30. In step 106, a modified component factor is determined based on the machine information 12, 14 and the first virtual geometry 32. In step 108, a second virtual geometry is generated based on the modified component factor. Preferably, a modified displacement factor 26′ and/or a modified tool factor 24′ based on the first virtual geometry 32 is determined for this, whereby basically the same procedure as in steps 102a-c is applicable.

The system for data processing 1 shown in FIG. 2 uses as input information 10, characterizing nominal geometry, information 12, characterizing axis positions, information 14, characterizing power values, meta information 16, and sensor information 18. The system 1 comprises means 210 for determining contact area 20 based on nominal geometry 10, axis positions 12, and meta information 16. The system 1 further comprises means 220 for determining process force 22 based on contact area 20, information 14, and sensor information. Further, the system 1 comprises means 230 for determining the tool factor 24 based on the process force 22 and the contact area 20.

Further, the system 1 comprises means 240 for determining the displacement factor 26 based on a tool and/or component displacement 26a,b. The tool and/or component displacement 26a,b is determined based on meta information 16, the nominal geometry 10, and the process force 22.

Further, the system 1 comprises means 250 for determining the position factor 28 based on the contact area 20 and the nominal geometry 10. The means 260 are arranged for generating the first virtual geometry 32, wherein the first virtual geometry 32 is generated based on the tool factor 24, the displacement factor 26, and the position factor 28. Furthermore, the system 1 comprises means 270 for determining a geometry deviation 34 based on the first virtual geometry 32 and the nominal geometry 10.

The first virtual geometry 32 may also be used as an input to the system 1. In particular, this represents an iteration loop, as will be explained in more detail below. Based on the virtual geometry 32, the information 20-34 can be determined by the means 210-270 with a higher accuracy, so that a resulting second virtual geometry 36 reproduces the component 8 produced or to be produced with a higher accuracy.

Sensor information 18 may additionally be used by means 220, 230, 240, 250 to perform the individual determinations with higher precision.

FIG. 3 illustrates these relationships at the information level. In particular, it is shown that the displacement factor 26 is determined on the basis of a tool displacement 26a and a component displacement 26b. Supplementally, an initial geometry 19 of the workpiece can be taken into account. In particular, it is preferred that the output geometry 19 is taken into account when determining the contact area 20 and when determining the displacement factor 26.

FIG. 4 shows the method for generating a second virtual geometry 36. Instead of the nominal geometry 10 as input, the first virtual geometry 32 is used here as input. Based on the information 10, 12, 14, 16, 32, a modified contact area 20′, a modified process force 22′, a modified tool factor 24′ and a modified displacement factor 26′ are determined.

Based on the modified tool factor 24′, the modified displacement factor 26′ and the position factor 28, the modified component factor 30′ is determined. Based on the modified component factor 30′, the second virtual geometry 36 is determined. Based on the second virtual geometry 36 and the nominal geometry 10, a modified component deviation 34′ is determined.

FIG. 5 shows a manufacturing system 3 which includes a processing machine 2 and a data processing system 1. The processing machine 2 has a machine spindle 4 for rotationally driving a tool 6. The tool 6 is used to produce the component 8, which is clamped by a clamping means 9. The processing machine 2 has three linear axes x, y, z. In addition, the processing machine 2 has a first swivel axis a, a second swivel axis b and a third swivel axis c. The processing machine 2 is coupled to the data processing system 1 by means of signals.

Through the coupling, a first virtual geometry 32 can be generated in-situ as a digital geometric image of the produced component 8. For this purpose, a component factor 30 is determined, based on machine information, in particular the axis positions 12 and the power values 14 of the processing machine 2, and the nominal geometry. The machine information 12, 14 is acquired, for example read out from a machine control of the processing machine 2. The mapping accuracy, i.e. the difference between the produced component and the virtual geometry, can be increased by iteration grinding. For this purpose, for example, a second virtual geometry 36 and/or a third virtual geometry and/or further virtual geometries are generated.

By the method and the system 1 described in the preceding, measuring methods can be eliminated from the manufacturing process chain. The basis for this is that the geometry of a produced component 8 is not determined on the basis of a measuring method, but on the basis of machine information 12, 14 and the predetermined nominal geometry 10. This allows 100% control of the produced components 8, so that rejects are reduced.

In addition, the costs of the process chain for complex components are reduced, since the 25% of the component costs for measuring processes mentioned at the beginning are eliminated. Furthermore, the method can also be completely virtual, so that adaptation of the NC code can take place on the basis of the first virtual geometry or the second virtual geometry. The basis for this is that the process force 22 can also be calculated.

Thus, a robust method is provided to predict the quality of components 8 on the one hand and to control it on the other hand.

### REFERENCE SIGNS

1 Data processing system
2 Processing machine
3 Manufacturing system
4 Machine spindle
6 Tool
8 Component
9 Clamping device
10 Information characterizing nominal geometry
12 Information characterizing axis positions
14 Information characterizing power values
16 Meta information
18 Sensor information
19 Output geometry
20 Information characterizing the contact area
20′ Information characterizing the modified contact area
22 Information characterizing the process force
22′ Information characterizing the modified process force
24 Information characterizing the tool factor
24′ Information characterizing the modified tool factor
26 Information characterizing the displacement factor
26′ information characterizing the modified displacement factor
26a Tool displacement
26b component displacement
28 Information characterizing the position factor
30 Information characterizing the component factor
30′ information characterizing the modified component factor
32 Information characterizing the first virtual geometry
34 Information characterizing a component deviation
34′ information characterizing a modified part deviation
36 Information characterizing the second virtual geometry
100-108 Process steps
210 Means for determining the contact area
220 Means for determining the process force
230 Means for determining the tool factor
240 Means for determining the displacement factor
250 Means for determining the position factor
260 Means for generating the first virtual geometry
270 Means for determining a geometry deviation
a Machine axis
b Machine axis
c machine axis
x machine axis
y machine axis
z machine axis

1. A computer-implemented method for generating a virtual geometry of a component which is produced and/or is to be produced with a processing machine and has a nominal geometry, comprising the steps:
acquiring machine information which characterizes at least one machine parameter of the processing machine which influences a geometry of the component,
determining at least one component factor based on the machine information and the nominal geometry, and
generating a first virtual geometry as a digital geometric image of the component produced and/or to be produced based on the component factor.

2. The method according to claim 1, wherein the machine information characterizes axis positions of at least one machine axis, or of two or more or all machine axes, and/or of a machine spindle of the processing machine.

3. The method according to claim 1, wherein the machine information characterizes power values of at least one machine axis, or of two or more or all machine axes, and/or of a machine spindle of the processing machine.

4. The method according to claim 3, comprising the steps of:
determining a process force using the power values and/or a contact area between an applied tool and the component, and
determining a displacement factor determined by using a tool displacement and/or a component displacement based on the process force,
wherein the component factor is determined based on the displacement factor.

5. The method according to claim 2, comprising the step of:
determining a position factor based on the axis positions, and
wherein the component factor is determined based on the position factor.

6. The method according to claim 1, comprising the step of:
determining a tool factor based on a tool geometry, and
wherein the component factor is determined based on the tool factor.

7. The method according to claim 1, wherein
a tool geometry is determined on the basis of an initial condition and/or on the basis of a tool wear, and
the tool wear is determined based on a contact area between an applied tool and the component and/or based on a process force.

8. The method according to claim 1, comprising the step of:
acquiring metainformation, wherein the metainformation represents tool parameters of an applied tool, machine kinematics of the processing machine and/or program names, and
wherein the metainformation is used to determine a displacement factor and/or to determine a contact area between the applied tool and the component.

9. The method according to claim 1, comprising the step of:
acquiring sensor information, wherein the sensor information characterizes force values, vibration values, and/or tool displacement values; and
wherein the sensor information is used to determine a process force.

10. The method according to claim 1, wherein a contact area between an applied tool and the component is determined based on a tool geometry of the applied tool and the nominal geometry of the component and/or the first virtual geometry.

11. The method according to claim 1, comprising the steps:
determining a modified component factor based on the machine information and the first virtual geometry;
generating a second virtual geometry based on the modified component factor; and
determining a modified displacement factor, a modified position factor and/or a modified tool factor based on the first virtual geometry and/or based on a deviation between the first virtual geometry and the nominal geometry.

12. The method according to claim 11, comprising the step of:
determining a geometry deviation by matching the first virtual geometry and/or the second virtual geometry with the nominal geometry; and
generating a deviation vector in predefined component sections of the nominal geometry in each case.

13. A method for generating a digital twin of a produced component based on the machine information and the nominal geometry of the component according to the method of claim 1.

14. A data processing system configured to carry out the steps of the method according to claim 1.

15. A computer program comprising instructions which, when the computer program is executed by a computer, cause the computer program to execute the method according to claim 1.
